(19) United States
(12) Patent Application Publication
(10) Pub. No.: US 2024/0273371 A1
(43) Pub. Date: Aug. 15, 2024

(54) CODE-LEVEL NEURAL ARCHITECTURE SEARCH USING LANGUAGE MODELS

(71) Applicant: Google LLC, Mountain View, CA (US)

(72) Inventors: Angelica Chen, Brooklyn, NY (US); David Richard So, Brooklyn, NY (US); David Martin Dohan, San Francisco, CA (US)

(21) Appl. No.: 18/431,804

(22) Filed: Feb. 2, 2024

Related U.S. Application Data
(60) Provisional application No. 63/443,005, filed on Feb. 2, 2023.

(51) Int. Cl. G06N 3/086

(52) U.S. Cl. CPC G06N 3/086

(57) ABSTRACT

Methods, systems, and apparatus, including computer programs encoded on a computer storage medium, for determining an architecture for a neural network configured to perform a machine learning task. In one aspect, a method comprises: receiving training data; searching for a final architecture of the neural network, wherein the searching comprises: maintaining current population data; and repeatedly performing evolutionary architecture search steps comprising: selecting one or more candidate architectures from the current population of candidate architectures defined by the source code included in the current population data; generating an input prompt; processing the input prompt using the language model neural network to generate output source code that defines a plurality of new candidate architectures; and using the plurality of new candidate architectures defined by the output source code to update the current population data.

### CROSS-REFERENCE TO RELATED APPLICATION

This application claims priority to U.S. Provisional Application No. 63/443,005, filed on Feb. 2, 2023. The disclosure of the prior application is considered part of and is incorporated by reference in the disclosure of this application.

### BACKGROUND

This specification relates to determining architectures for neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of weights.

### SUMMARY

This specification describes a neural architecture search (NAS) system implemented as computer programs on one or more computers in one or more locations that determines an architecture for a neural network configured to perform a machine learning task.

The subject matter described in this specification can be implemented in particular embodiments so as to realize one or more of the following advantages. Existing neural architecture search systems are usually limited to a closed search space, e.g., a space consisting of high-level modules, function statements, or basic mathematical operations, that has to be carefully designed and specified. By expanding a neural architecture search space to cover practically any architecture that can be defined by computer source code, the neural architecture search techniques described in this specification allow for greater flexibility and diversity of the architectures that can be determined, and reduces the amount of manual design and potential human bias involved in the search process.

The described neural architecture search techniques combine the knowledge about code structure and functionality learned by a pre-trained language model neural network with prompting techniques, e.g., evolutionary prompt engineering techniques, soft prompt tuning techniques, or both to extend the capability of the language model neural network to generation of computer source code that defines neural network architectures that satisfy desired performance metrics. A neural architecture system that employs the described techniques can effectively and automatically, i.e., with no or minimal user intervention, generate neural networks that are able to achieve performance competitive with or exceeding state-of-the-art models on a wide range of tasks while having relatively smaller model sizes, thus being more suitable for deployment on mobile devices, embedded systems, or other hardware platforms with limited computational resources. Once trained and deployed, a neural network that has a candidate architecture generated using the language model neural network can achieve or even exceed the performance of a neural network that has a conventional architecture, or an architecture that has been determined using a conventional neural architecture search process. From another point of view, this increase in performance makes possible a reduction in training time and/or computing resource requirement compared to a known neural network which performs the same task with the same accuracy.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural architecture search system.

FIG. 2 shows an example illustration of operations performed by a neural architecture search system.

FIG. 3 is a flow diagram of an example process for searching for a final architecture for a neural network.

FIG. 4 is a flow diagram of sub-steps of one of the steps of the process of FIG. 3.

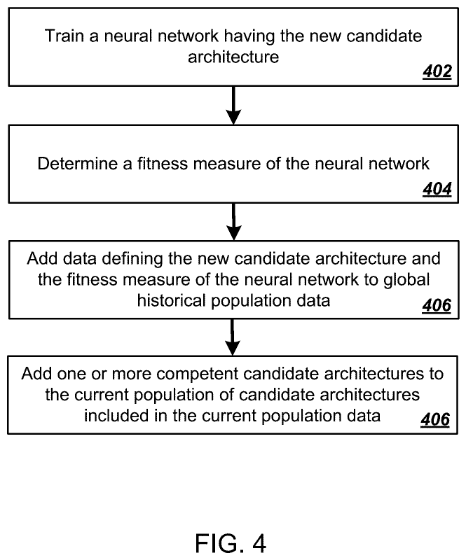

Like reference numbers and designations in the various drawings indicate like elements.

### DETAILED DESCRIPTION

This specification describes a neural architecture search (NAS) system implemented as computer programs on one or more computers in one or more locations that determines an architecture for a neural network configured to perform a machine learning task.

The neural network can be trained to perform any kind of machine learning task, i.e., can be configured to receive any kind of digital data input and to generate any kind of score, classification, or regression output based on the input.

In some cases, the neural network is a neural network that is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the neural network is a neural network that is configured to perform an image generation task, where the input is a conditioning input and the output is a sequence of intensity value inputs for the pixels of an image.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language—target language pairs. In this example, the source language text may be augmented with an identifier that indicates the target language into which the neural network should translate the source language text.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the task is a multi-modal task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

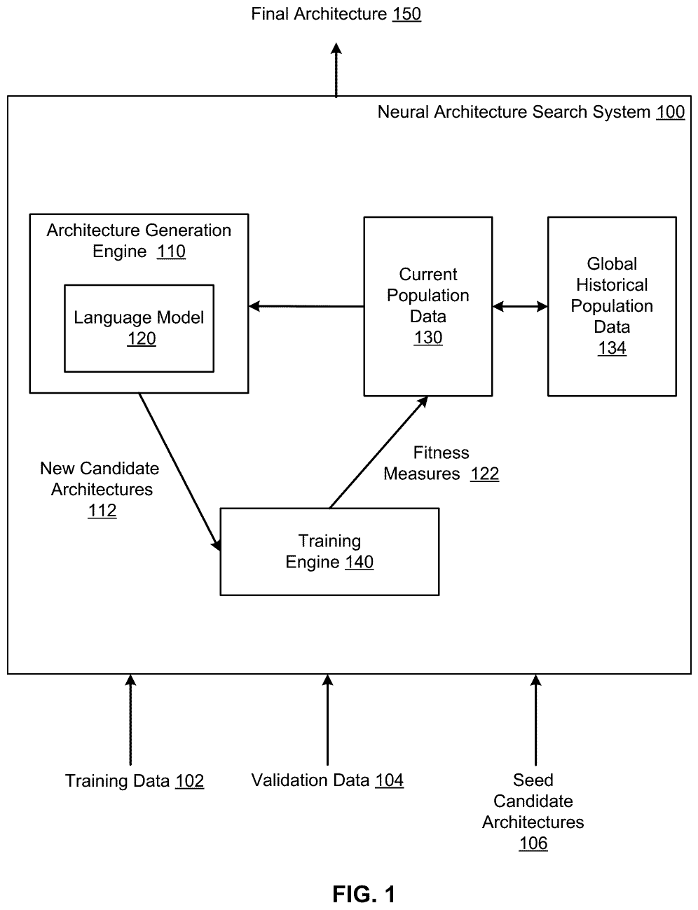

FIG. 1 shows an example neural architecture search (NAS) system 100. The neural architecture search system 100 is an example of a system implemented as computer programs on one or more computers in one or more locations, in which the systems, components, and techniques described below can be implemented.

The NAS system 100 is a system that obtains training data 102 for training a neural network to perform a particular task and a validation set 104 for evaluating the performance of the neural network on the particular task and uses the training data 102 and the validation set 104 to determine an architecture for a neural network that is configured to perform the particular task.

For example, the architecture defines the number of layers in the neural network, the input/output dimensions of each of the layers, the operations performed by each of the layers, and the connectivity between the layers in the neural network, i.e., which layers receive inputs from which other layers in the neural network.

Generally, the training data 102 and the validation set 104 both include a set of training examples and, for each training example, a respective target output that should be generated by the neural network to perform the particular task. For example, a larger set of training data may have been randomly partitioned to generate the training data 102 and the validation set 104.

The CIFAR-10 dataset, which consists of 60000 training examples paired with a target output classification selected from ten possible classes, is an example of such training data in cases where the particular task is an image processing task. CIFAR-1000 is a related dataset where the classification is one of 1000 possible classes. Another example of suitable training data in cases where the particular task is an image processing task is the ImageNet dataset, which consists of more than 14 million images paired with a target output classification selected from more than 20000 possible classes. Some or all of these images are also paired with bounding box data that specify the boundaries of the regions in which an object belonging to one of the possible classes is present.

The NAS system 100 can receive the training data 102 and the validation set 104 in any of a variety of ways. For example, the NAS system 100 can receive training data as an upload from a remote user of the system over a data communication network, e.g., using an application programming interface (API) made available by the NAS system 100, and randomly divide the uploaded data into the training data 102 and the validation set 104. As another example, the NAS system 100 can receive an input from a user specifying which data that is already maintained by the NAS system 100 or another system accessible by the NAS system 100 should be used for training the neural network, and then divide the specified data into the training data 102 and the validation set 104.

Generally, the NAS system 100 determines the architecture for the neural network by repeatedly modifying architectures in a set of candidate architectures, evaluating the performance of the modified architectures on the task, and then adding the modified architectures to the set in association with fitness measures that reflect the performance of the modified architectures on the task.

In particular, the NAS system 100 maintains current population data 130 specifying a set of current candidate architectures and associating each current candidate architecture in the set with a corresponding fitness measure 112. Likewise, the NAS system 100 maintains global historical population data 134 specifying a set of historical candidate architectures and associating each historical candidate architecture in the set with a corresponding fitness measure 112.

As will be explained further below, the current population data 130 differs from the global historical population data 134 in how they are initialized, e.g., in the number of candidate architectures that are included therein prior to the beginning of a search process, as well in how they are updated throughout the search process, e.g., whether and, if so, how the candidate architectures are removed therefrom.

Although this specification generally discusses maintaining both current population data 130 and global historical population data 134 to facilitate the search, maintaining the current population data is in fact optional and not a necessity. In some implementations, the system need not maintain the current population data 130 separate from the global historical population data 134. Instead, the current population data 130 may be considered a subset of the global historical population data 134.

The NAS system 100 repeatedly adds new candidate architectures 112 and corresponding fitness measures 122 to the current population data 130 and to the global historical population data 134 by performing the search process across a plurality of evolutionary search iterations and, after the search process has terminated, uses the fitness measures 122 for the architectures in the global historical population data 134 to determine the final, e.g., optimized, architecture 150 for the neural network.

Each candidate architecture in the set is defined by source code written in any of a variety of computer programming languages. For example, the source code defining a candidate architecture can be written in a high-level programming language, e.g., Python, C++, C #, Java, Ruby, PHP, and so on. As another example, the source code defining a candidate architecture can be written in a low-level language such as assembly language.

Defining candidate architectures by source code allows for greater flexibility and diversity of the architectures that can be determined compared to some conventional neural architecture search systems in which the candidate architectures are defined by cells, blocks, or other modules that can be repeated multiple times throughout the neural network, or that are defined by a predetermined set of hyperparameters. Rather, the NAS system 100 expands the neural architecture search space to cover practically any architecture that can be defined by computer source code. In particular, by using suitable prompting techniques, e.g., evolutionary prompt engineering techniques, soft prompt tuning techniques, or both, the NAS system 100 overcomes the difficulties faced by source code-level neural architecture search, e.g., defining architectures using open-ended source code has conventionally made it difficult to mutate architectures in a meaningful way (e.g., since it's unclear which code fragments to modify or how to modify the code fragments).

In FIG. 1, the current population data 130 and the global historical population data 134 can each include, as candidate architectures, one or more of: feed-forward architectures (e.g., architectures for a convolutional neural network or a Transformer neural network), recurrent architectures (e.g., architectures for a long short term memory (LSTM) neural network or a gated recurrent unit (GRU) neural network), or graph neural network architectures (e.g., architectures for a graph attention network, a message-passing neural network, a pointer graph network, or the like), to name merely a few examples.

The current population data 130 can be initialized to include a plurality of seed candidate architectures 106. For example, the NAS system 100 can receive source code as an upload from a remote user of the system that defines a set of one or more seed candidate architectures 106, and initialize the current population data 130 with the set of seed candidate architectures 106. That is, prior to the beginning of the search process, the current population data 130 includes the set of seed candidate architectures 106.

The global historical population data 134 can be initialized as an empty data set, i.e., the global historical population data 134 includes no candidate architectures at the beginning of the search process.

TABLE 1 includes an example of custom source code that defines a convolutional layer as a part of one of the seed candidate architectures.

TABLE 1

| | |
|---|---|
| 1 | def_ _call_ _(self, x): |
| 2 | x = x [..., None] |
| 3 | x = nn.Conv(features = self.features, kernel_size = |
| 4 | (3,))(x) |
| 5 | x = nn.relu(x) |

TABLE 2 includes an example of custom source code that defines another convolutional layer as a part of another one of the seed candidate architectures.

TABLE 2

| | |
|---|---|
| 1 | def_ _call_ _(self, x): |
| 2 | x = x [..., None] |
| 3 | x = nn.Conv(features = self.features, kernel_size = |
| 4 | (5,), strides = (2,), padding = (1,))(x) |
| 5 | x = nn.relu(x) |

TABLE 3 includes an example of custom source code that defines a fully-connected layer associated with a ReLU activation function as a part of another one of the seed candidate architectures.

TABLE 3

| | |
|---|---|
| 1 | def_ _call_ _(self, x): |
| 2 | x = nn.Dense(features = self.hidden_size)(x) |
| 3 | x = nn.relu(x) |
| 4 | x = x + nn.relu(nn.Dense(features = |
| 5 | self.hidden_size)(x)) |
| 6 | x = nn.Dense(features = 10)(x) |
| 7 | return x |

An advantage of the NAS system 100 described in this specification is therefore the capability to allow users to initialize the population data 130 by writing relatively small amounts of code, e.g., in Python, C++, C#, Java, Ruby, PHP, or another high-level programming language that defines the seed candidate architectures to be included in the population data 130. Initializing the population data 130 based on custom source code is vastly faster and more flexible than traditional NAS systems which require teams of many machine learning experts to work for many days or weeks to manually design a search space for each given task that might include potential human bias toward (or against) certain architectures, and that does not generalize to other tasks.

To determine the final architecture 150, the NAS system 100 repeatedly performs the search process using an architecture generation engine 110 and a training engine 140.

The architecture generation engine 110 repeatedly, i.e., at each evolutionary search iteration, (i) selects one or more candidate architectures from the current population of candidate architectures included in the current population data 130 and (ii) generates a plurality of new candidate architectures 112 based on the one or more selected candidate architectures.

In particular, the architecture generation engine 110 generates the new candidate architecture 112 for the neural network by using a language model neural network 120 (or “language model” for short). At each evolutionary search iteration, the architecture generation engine 110 generates one or more input prompts that are submitted to the language model 120, and causes the language model 120 to generate output source code that defines the plurality of new candidate architectures 112.

Each input prompt can include source code that defines the one or more selected candidate architectures. For example, the selected candidate architectures could include architectures determined in previous evolutionary search iterations of the search process. The input prompt can also include a set of performance metrics for each selected candidate architecture. The input prompt can further include a target set of performance metrics for a final architecture.

In some cases, the target set of performance metrics is fixed, e.g., they may be defined or otherwise specified by a user of the system upon the beginning of the search process. In other cases, the target set of performance metrics can be dynamically adjusted by the architecture generation engine 110 as the search progresses, e.g., based on the sets of performance metrics for the candidate architectures generated in previous iterations. In general the set of target performance metrics will be determined in a way that improves over the sets of performance metrics of the one or more selected candidate architectures.

For example, when the target set of performance metrics include a model size, the target model size for a given evolutionary search iteration can be a fraction (e.g., 95%, 90%, 80%, or the like) of the smallest model size among the model sizes of the candidate architectures included in the current population data 130 as of a previous evolutionary search iteration. As another example, when the target set of performance metrics include a validation error, the target validation accuracy for a given evolutionary search iteration can analogously be a fraction (e.g., 95%, 98%, 99%, or the like) of the lowest validation error among the validation errors of the candidate architecture included in the current population data 130 as of the previous evolutionary search iteration.

For example, the input prompt could take the following form as shown in TABLE 4:

TABLE 4

| | |
|---|---|
| 1 | “““ Metrics: |
| 2 | {‘ num_params':‘4800’, ‘val_accuracy’: ‘0.865’} |
| 3 | ””” |
| 4 | class Model(nn.Module): |
| 5 | @nn. compact |
| 6 | def _ _call_ _(self, x): |
| 7 | x = nn.Dense(features = 10)(x) |
| 8 | return x |

This example input prompt includes (i) a selected candidate architecture (a fully-connected layer with 10 output units) defined in lines 4-8 and (ii) a set of performance metrics for the selected candidate architecture defined in lines 1-3: model size (4800 parameters) and validation accuracy (0.865). Note that this example input prompt does not include a set of target performance metrics that improve over the performance metrics for the selected candidate architecture. But when included, they can be added, e.g., to the top, bottom, or anywhere else in between the 8 lines of source code shown above.

The language model 120 can be any appropriate language model neural network that receives an input prompt and processes the input prompt to auto-regressively generate an output sequence that includes a plurality of computer code tokens that specifies a new candidate architecture 112 for a neural network configured to perform the machine learning task. Each computer code token is selected from a vocabulary of computer code tokens that represent code symbols in one or more computer programming languages, e.g., Python, C++, C #, Java, Ruby, PHP, and so on.

More specifically, the auto-regressively generated output sequence is created by generating each particular token in the output sequence conditioned on a current input sequence that includes any tokens that precede the particular text token in the output sequence, i.e., the tokens that have already been generated for any previous positions in the output sequence that precede the particular position of the particular token.

For example, the language model 120 can have any of a variety of Transformer-based neural network architectures. Examples of such architectures include those described in Thoppilan Romal, et al., Lamda: Language models for dialog applications. arXiv preprint arXiv:2201.08239; Brown, Tom, et al., Language models are few-shot learners. arXiv preprint arXiv:2005.14165, 2020; and Chowdhery Aakanksha, et al., Palm: Scaling language modeling with pathways. Journal of Machine Learning Research, 24(240), pp. 1-113.

Generally, because the language model 120 is auto-regressive, at each evolutionary search iteration, the architecture generation engine 110 can use the same language model 170 to generate multiple different output sequences in response to the same input prompt, e.g., by using mixed temperature sampling, nucleus sampling, greedy sampling, or another decoding strategy that leverages the auto-regressive nature of the language model.

For example, the output sequence could take the following form as shown in TABLE 5:

TABLE 5

| | |
|---|---|
| 1 | def get_triplet_msgs_quad (z, edge_fts, graph_fts, |
| 2 | nb_triplet_fts, out_size): |
| 3 | node_reps = [hk.Linear(nb_triplet_fts) for _ in |
| 4 | range(4)] |
| 5 | triplet_node_reps = [node_rep(z) for node_rep in |
| 6 | node_reps] |
| 7 | node_pair_inversions = [(1, 2), (1, 3), (2, 3), (3, |
| 8 | 1)] |
| 9 | triplets = functools.reduce( |
| 10 | lambda x, y: x + y, |
| 11 | [ |
| 12 | jnp.expand_dims(tri_node_rep, axis = perm) |
| 13 | for tri_node_rep, perm in zip( |
| 14 | triplet_node_reps, node_pair_inversions |
| 15 | ) |
| 16 | ], |
| 17 | ) |
| 18 | return jnp.max(triplets, axis =1) − |
| 19 | jnp.min(triplets, axis = 1) |

This example output sequence includes source code written in Python that defines a new candidate architecture (a graph neural network architecture).

In some implementations, the NAS system 100, or a separate training system, can train the language model 120 on a language modeling task, e.g., a task that requires predicting, given a current sequence of tokens, the next token that follows the current sequence in the training data. As a particular example, the language model 120 can have been pre-trained on a maximum-likelihood objective on a large dataset of text, e.g., a corpus of conversational, web, and code documents that is publicly available on the Internet, and subsequently fine-tuned on a large corpus of source code from a code repository.

At each evolutionary search iteration, for each new candidate architecture 112 defined by an output sequence of the language model 120, the training engine 140 trains an instance of the neural network that has the new candidate architecture 112 on the training data 102, e.g., for a fixed number of training iterations, and determines a fitness measure 122 for the trained neural network that measures the performance of the trained neural network on the particular machine learning task, i.e., based on evaluating the performance metric of the trained neural network, e.g., on the validation data 104 or based on intrinsic characteristics of the neural network.

In some implementations, the performance metrics include the loss of the trained neural network on the validation data 104 or the result of some other measure of model error when computed over the validation data 104. For example, the loss can be a cross-entropy loss function when the task is a classification task, or a mean squared error (MSE) loss function when the task is a regression task.

In other implementations, the performance metrics include the intrinsic performance of the neural network. For example, the intrinsic performance can include the model size (e.g., total number of parameters), inference latency (when deployed on one or more hardware computing devices, e.g., hardware accelerators such as TPUs, GPUs and ASICs), or both of the neural network that has the new candidate architecture.

In yet other implementations, the performance metrics include both the validation loss and the intrinsic performance.

The fitness measure 112 will depend on the performance metrics. In other words, the fitness measure 112 will depend on validation loss, the intrinsic performance, or both the validation loss and the intrinsic performance. Generally, higher fitness measures indicate better performance on the particular machine learning task.

For example, the fitness measure 112 can be a combination, e.g., a weighted or unweighted sum, or a product, e.g., a positive or negative product, of the validation loss and the model size. As another example, more sophisticated functions can be used, for example, to achieve multi-objective (e.g., dual-objective) neural architecture search, as described in Bender, G., et al., Can weight sharing outperform random architecture search? an investigation with tunas. 2020 IEEE/CVF Conference on Computer Vision and Pattern Recognition (CVPR), pp. 14311-14320, 2020.

The NAS system 100 then updates the current population data 130 and the global historical population data 134 using the data that defines the new candidate architectures 112 and the fitness measure 122 of the neural networks having the new candidate architectures.

More specifically, the NAS system 100 adds, to the global historical population data 134, data that defines each new candidate architecture 112 defined by an output sequence of the language model 120 and data associating each candidate architecture 112 with the fitness measure 122 of the neural network having the new candidate architecture.

The NAS system 100 also selects, from among the historical population of candidate architectures included in the global historical population data 134, one or more competent candidate architectures that each have a fitness measure that satisfy a fitness measure threshold, and adds the one or more competent candidate architectures to the current population of candidate architectures included in the current population data 130.

For example, the NAS system 100 selects, as the competent candidate architectures, candidate architectures that have the highest fitness measures among the historical population of candidate architectures. As another example, the NAS system 100 selects, as the competent candidate architectures, candidate architectures from the historical population of candidate architectures that each have a fitness measure that is above a predetermined fitness measure.

In some implementations, the NAS system 100 further adds, to the current population data 130, data associating the one or more competent candidate architectures with their fitness measures 122. In some implementations, the one or more competent candidate architectures are removed from the historical population of candidate architectures after they have been selected and added to the current population of candidate architectures. That is, the NAS system 100 deletes the maintained data that defines the one or more competent candidate architectures from the global historical population data 134.

Optionally, between at least some of the evolutionary search iterations across the search process, the architecture generation engine 110 adjusts the language model 120 to improve the diversity, quality, or both of the computer code that will be generated by the language model 120 in the next iterations. As explained below, some of these adjustments may involve updating the parameter values of the language model 120 while others of these adjustment may hold the pre-trained parameter values of the language model 120 fixed.

In some implementations, the architecture generation engine 110 uses a prompt engineering technique to adjust to language model 120. Prompt engineering may not involve applying updating to the pre-trained parameter values of the language model 120. Instead, prompt engineering involves providing more context, examples, or both to the language model 120 about the search process.

For example, the architecture generation engine 110 generates one or more input prompts that each include the source code that defines one or more candidate architectures and, optionally, a set of performance metrics of each candidate architecture and possibly other guidance information about how certain aspects of the candidate architectures affect the performance metrics, and submits the input prompts to the language model 120 for processing.

In some implementations, the one or more candidate architectures are randomly selected, e.g., from the current population of candidate architectures maintained in the current population data 130. In some implementations, the one or more candidate architectures are selected according to their fitness measures, e.g., the candidate architectures that have the highest fitness measures from the current population of candidate architectures can be selected. In some other implementations, the one or more candidate architectures are selected using a more sophisticated strategy.

As an example of such strategy, the architecture generation engine 110 can compare (i) the plurality of new candidate architectures 112 defined by the output source code generated by the language model 120 in the current evolutionary search iteration to (ii) the current population of candidate architectures included in the current population data 130, to determine a difference set that includes new candidate architectures that have been generated by using the language model 120 but are not selected for inclusion in the current population of candidate architectures. Source code defining these unselected, new candidate architectures included in the difference set can then be included in one or more of the input prompts to be processed by the language model 120.

In some implementations, the architecture generation engine 110 uses a prompt tuning technique to adjust the language model 120. Prompt tuning involves learning a soft prompt embedding that is provided alongside the embeddings of the input prompt to the language model 120, while holding the original parameters of the language model 120 fixed. That is, the soft prompt embeddings are in the same space of the embeddings of the input prompts that are generated by the embedding layer of the language model 120. Once learned, such a soft prompt embedding will then be processed by the language model 120 in addition to embeddings of each input prompt in the next evolutionary search iteration.

In prompt tuning, the architecture generation engine 110 generates one or more input prompts that each include the source code that defines one or more candidate architectures (that are selected in any of a variety of ways as described above), and trains the language model 120 to adjust the soft prompt embedding based on optimizing a prompt tuning objective function based on processing the one or more input prompts and the soft prompt embedding.

For example, the prompt tuning task can be a task that requires predicting, given a current sequence of tokens in a given input prompt, the next tokens that follow the current sequence in the given input prompt. The architecture generation engine 110 then computes a loss of the language model 120 that is determined by using a prompt tuning objective function that evaluates a difference between the predicted next tokens and the actual next tokens, and uses the loss to determine the updates to the soft prompt embedding, e.g., by backpropagating the gradients of the loss into the soft prompt embedding.

Suitable techniques for identifying the predetermined set of tokens and updating the prompt parameters that can be used by the architecture generation engine 110 are described in Lester, Brian, et al., “The power of scale for parameter-efficient prompt tuning.” arXiv preprint arXiv:2104.08691 (2021).

In some implementations, the architecture generation engine 110 uses a fine-tuning technique to adjust the language model 120. Unlike the prompt tuning which involves training only a small subset of the parameters of the language model 120, fine-tuning will generally involve updating more (e.g., all) of the parameters of the language model 120 by training the language model 120 based on optimizing a fine-tuning objective function using the one or more input prompts.

Once termination criteria for the search process have been satisfied, e.g., after more than a threshold number of iterations of the search process have been performed or after the best fit candidate architecture in the historical population of candidate architectures has a fitness measure that satisfies a threshold, the NAS system 100 selects a neural network architecture from the candidate architectures remaining in the historical population or, in some implementations, from all of the candidate architectures that were in the historical population at any point during the search process.

That is, in some implementations, the NAS system 100 selects the candidate architecture in the historical population that has the best (highest) fitness measure, while in other implementations, the NAS system tracks the fitness measures for candidate architectures even after those candidate architectures are removed from the historical population, and selects the candidate architecture that has the best fitness measure using the tracked fitness measures.

The NAS system 100 can then output architecture data that specifies the final architecture 150 of the neural network, e.g., data specifying the number of layers in the neural network, the input/output dimensions of each of the layers, the operations performed by each of the layers, and the connectivity between the layers in the neural network.

For example, the NAS system 100 provides the data specifying the final architecture 150 and, optionally, the trained parameter values, in response to receiving the training data 102, e.g., to the user that submitted the training data 102 over a data communication network.

In an analogous manner, the NAS system 100 can provide the fitness measures, e.g., the fitness measure of best fit candidate architecture or the fitness measures of top-n most fit candidate architectures, for presentation to the user that submitted the training data 102, i.e., as an indication that a well-performing architecture has been found, or store the fitness measure in association with the trained values of the parameters of the trained neural network.

In some implementations, instead of or in addition to outputting the architecture data, the NAS system 100 instantiates an instance of the neural network having the determined final architecture 150 and with trained parameters, e.g., either trained from scratch by the system after determining the final architecture 150, making use of the parameter values generated as a result of the search process, or generated by fine-tuning the parameter values generated as a result of the search process, and then uses the trained neural network to process requests received by users, e.g., through the API provided by the system.

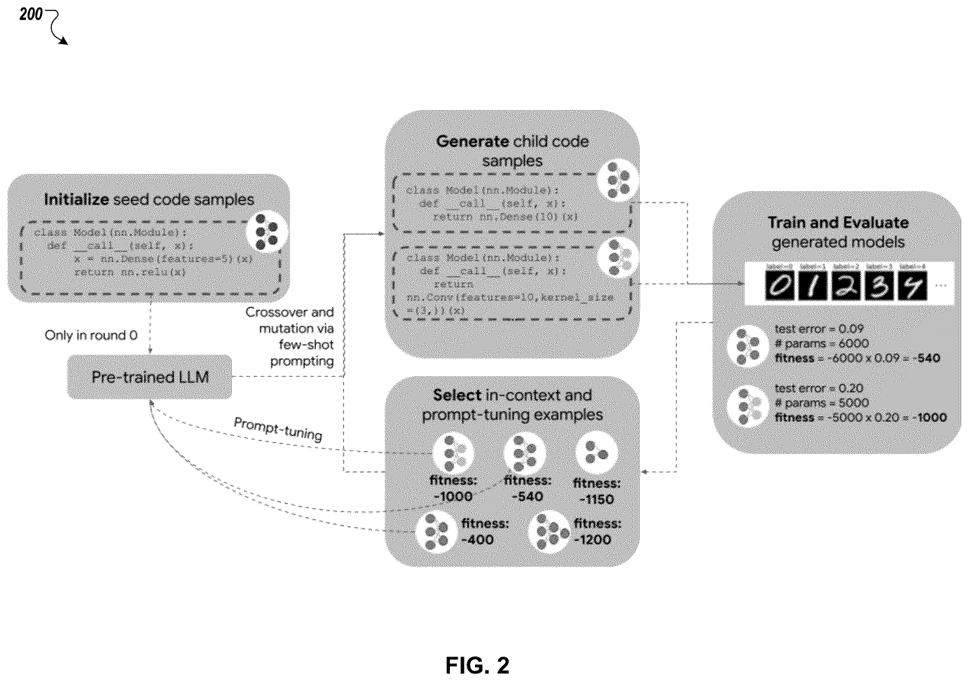

FIG. 2 shows an example illustration 200 of operations performed by the neural architecture search system 100 of FIG. 1. The neural architecture search (NAS) system 100 performs these operations using a language model and a training engine across a plurality of evolutionary search iterations.

To begin the search process, i.e., prior to the first evolutionary search iterations, the neural architecture search system 100 receives source code that defines a set of seed candidate architectures.

At each evolutionary search iteration, the NAS system 100 selects one or more candidate architectures from the current population of candidate architectures included in the current population data, and generates an input prompt that includes source code that defines the one or more selected candidate architectures, and, for each selected candidate architecture, a set of performance metrics for the selected candidate architecture. Optionally the input prompt also includes a target set of performance metrics.

The NAS system 100 submits the input prompt to the language model, and causes a language model to generate one or more output sequences from processing the input prompt. Each output sequence includes a plurality of computer code tokens that specifies a new candidate architecture for a neural network. That is, the NAS system 100 generates an input prompt and samples a set of output sequences from the language model while the language model is conditioned on the input prompt.

Generating the input prompt and processing the input prompt to generate the output sequences are collectively referred to as the “crossover and mutation via few-shot prompting” operations in FIG. 2.

For each new candidate architecture defined by an output sequence of the language model, the NAS system 100 uses a training engine to train an instance of the neural network that has the new candidate architecture and then determines a fitness measure of the trained neural network that measures the performance of the trained neural network on the particular machine learning task.

In FIG. 2, the fitness measure is computed as a negative product of validation error and model size of the trained neural network. For example, assuming that a first trained neural network has a validation error is 0.09 and has 6000 parameters, then its fitness measure is determined as −6000×0.09=−540. As another example, assuming that a second trained neural network has a validation error is 0.20 and has 5000 parameters, then its fitness measure is determined as −5000×0.20=−1000. Generally, higher fitness measures indicate better performance on the particular machine learning task; thus first trained neural network has a better performance than the second trained neural network.

The NAS system 100 updates the current population data and the global historical population data using the data that defines the new candidate architectures and the fitness measure of the neural networks having the new candidate architectures.

In some implementations, the NAS system 100 moves on to the next evolutionary search iteration, i.e., performs another iteration of the “crossover and mutation via few-shot prompting” operations.

In other implementations, before moving on to the next evolutionary search iteration, the NAS system 100 uses a prompt tuning technique to adjust the language model such that it can generate more diverse, higher quality, or both output source code that defines candidate architectures.

In prompt tuning, the NAS system 100 generates one or more input prompts and trains the language model to adjust a subset of the parameter values of the language model based on optimizing a prompt tuning objective function using the one or more input prompts.

For example, the input prompts can include source code that defines a predetermined number of candidate architectures that have the highest fitness measures from the current population of candidate architectures. Generating the input prompt for prompt tuning the language model is referred to as the “select in-context and prompt-tuning examples” operations in FIG. 2.

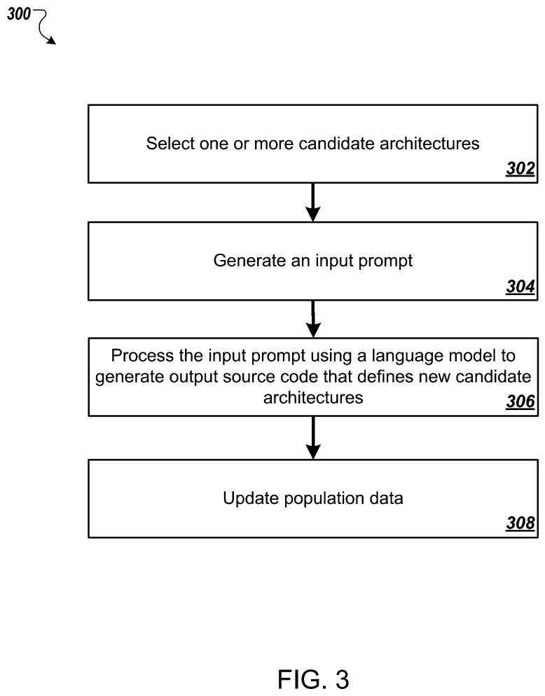

FIG. 3 is a flow diagram of an example process 300 for searching for a final architecture for a neural network using a language model. The neural network can be configured to perform a particular machine learning task. For convenience, the process 300 will be described as being performed by a system of one or more computers located in one or more locations. For example, a neural architecture search system, e.g., the neural architecture search (NAS) system 100 of FIG. 1, appropriately programmed, can perform the process 300.

As described above, to begin the search for the final architecture the system receives training data for training a neural network to perform a machine learning task, and then during the search for the architecture the system maintains current population data and historical population data. The training data includes a plurality of training examples and a respective target output for each of the training examples.

The current population data includes, for each candidate architecture in a current population of candidate architectures, (i) source code defining the candidate architecture, and (ii) a fitness measure representing a performance of the candidate architecture. In some implementations, the system initializes the current population data with a plurality of seed candidate architectures. For example, the plurality of seed candidate architectures can be defined by source code uploaded by a user to the system.

Likewise, the historical population data includes, for each candidate architecture in a historical population of candidate architectures, (i) source code defining the candidate architecture, and (ii) a fitness measure representing a performance of the candidate architecture. In some implementations, the system initializes the global historical population data as an empty data set, i.e., the global historical population data includes no candidate architectures at the beginning of the search process.

The system can then repeatedly perform an iteration of the process 300 at each of multiple evolutionary search iterations to update the set of candidate architectures in the maintained current population data and the set of candidate architectures in the maintained global historical population data.

The system selects one or more candidate architectures from the current population of candidate architectures defined by the source code included in the current population data (step 302). In some implementations, the system selects a candidate architecture randomly from the current population of candidate architectures. In some other implementations, the system selects the one or more candidate architectures based on their fitness measures.

For example, the system selects, as the one or more candidate architectures, candidate architectures that have the highest fitness measures among the current population of candidate architectures. As another example, the system selects, as the one or more candidate architectures, candidate architectures from the current population of candidate architectures that each have a fitness measure that is above a predetermined fitness measure.

The system generates an input prompt that comprises (i) the source code defining the one or more selected candidate architectures and (ii) a set of performance metrics of the one or more selected candidate architecture (step 304). For example, for each selected candidate architecture, the performance metric can include a validation loss of a trained neural network that has the selected candidate architecture, a model size of the trained neural network that has the selected candidate architecture, or both.

In some implementations, the input prompt also comprises a set of target performance metrics of the one or more new candidate architectures. The set of target performance metrics generally improves over the sets of performance metrics of the one or more selected candidate architectures, e.g., can include lower validation loss, smaller model size, or both.

The system processes the input prompt using the language model in accordance with the parameters of the language model to auto-regressively generate a plurality of output sequences (step 306). For example, the language model can have any of a variety of Transformer-based neural network architectures. Each output sequence includes a plurality of computer code tokens that defines a new candidate architecture. Each computer code token is selected from a vocabulary of computer code tokens that represent code symbols in one or more computer programming languages, e.g., Python, C++, C#, Java, Ruby, PHP, and so on.

The system updates the current population data and the global historical population data using the plurality of new candidate architectures generated by using the language model (step 308). This is described in more detail below with reference to FIG. 5, which shows sub-steps 402-406 corresponding to step 308.

For each new candidate architecture generated by using the language model at the evolutionary search iteration, the system trains a neural network having the new candidate architecture on the training data until termination criteria for the training are satisfied (step 402).

That is, for each new candidate architecture, the system instantiates a neural network having the candidate architecture and trains the instance on the received training data to perform the particular neural network task using a conventional machine learning training technique that is appropriate for the task, e.g., stochastic gradient descent with backpropagation or backpropagation-through-time. In some implementations, the system parallelizes the training of the neural networks to decrease the overall time needed for the search process. The system can train each neural network for a specified amount of time or a specified number of training iterations.

For each new candidate architecture, the system evaluates the performance of the corresponding trained instance of the neural network on the particular neural network task to determine a fitness measure of the neural network having the new candidate architecture after the training (step 404). For example, the fitness measure can be a combination, e.g., a weighted or unweighted sum, or a product, e.g., a positive or negative product, of (i) the validation loss of the trained instance of the neural network on the validation data as measured by an appropriate loss function and the model size of the trained instance of the neural network.

The system adds data defining the new candidate architectures and the fitness measures of the neural networks having the new candidate architectures to the global historical population data that includes the historical population of candidate architectures (step 406).

The system selects, from among the historical population of candidate architectures included in the global historical population data, one or more competent candidate architectures that each have a fitness measure that satisfy a fitness measure threshold, and then adds the one or more competent candidate architectures to the current population of candidate architectures included in the current population data (step 408). In some implementations, after adding the one or more competent candidate architectures to the current population of candidate architectures, the system removes them from the global historical population data.

For example, the competent candidate architectures can be candidate architectures that have the highest fitness measures among the historical population of candidate architectures. As another example, the competent candidate architectures can be candidate architectures from the global historical population of candidate architectures that each have a fitness measure that is above a predetermined fitness measure.

Example algorithms for searching for a final architecture for a neural network using a language model are shown below.

Algorithm 1 Complete meta-learning evolutionary algorithm
using p_{θ} as a crossover and mutation operator.

| | |
|---|---|
| 1: | Input: LM π_{θ}_{₀}, dataset [symbol] , task [symbol] , T number of rounds, m |
| | number of few-shot prompts per round, n number of samples to |
| | generate per prompt, k number of in-context examples per prompt, |
| | p number of survivors to select per generation, α the upper |
| | threshold for the test error |
| 2: | G ← [symbol] |
| 3: | P ← INITIALIZEPOPULATION(p) |
| 4: | t ← 0 |
| 5: | while t < T do |
| 6: | C ← CROSSMUT(π_{θ}_{ₜ}, P, m, k, n) |
| 7: | C_{EVALED} ← FILTERANDEVAL(C, [symbol] , [symbol] , α) |
| 8: | G ← G + C_{EVALED} |
| 9: | if t < T − 1 then |
| 10: | P ← GETTOP(G,p) |
| 11: | θₜ₊₁ ← TRAIN(θₜ, C_{EVALED} \ P) |
| 12: | end if |
| 13: | t ← t + 1 |
| 14: | end while |
| 15: | Return GETTOP(G,p) |

Algorithm 2 The crossover and mutation algorithm,
CROSSMUT(π_{θt}, P, m, k, n), where Uniform(P) denotes the
uniform distribution over the set P. The set of potential
parents P consists of the top examples from the previous round.

| | |
|---|---|
| 1: | Input: LM π_{θ}, population of code samples and fitnesses P = |
| | {(c, s) \| c ∈ V*, [symbol] (c, [symbol] ) = s}, m number of few-shot |
| | prompts to create, k number of in-context examples in each |
| | prompt, and n number of samples to sample per prompt. |
| 2: | C ← [symbol] |
| 3: | i ← 0 |
| 4: | while i < m do |
| 5: | E ← {xⱼ}ⱼ₌₁^{k}, where xⱼ [symbol] Uniform(P) |
| 6: | p ← MAKEFEWSHOTPROMPT(E) |
| 7: | Cᵢ ← {cⱼ}ⱼ₌₁ⁿ, where cⱼ [symbol] π_{θ}(·\|p) |
| 8: | C ← C + Cᵢ |
| 9: | i ← i + 1 |
| 10: | end while |
| 11: | Output: C |

Algorithm 3 The algorithm for filtering and scoring child models,
FILTERANDEVAL(C, [symbol] , [symbol] , α).

| | |
|---|---|
| 1: | Input: set of code samples C, task [symbol] , dataset [symbol] , evaluation |
| | function EVAL [symbol] (c, [symbol] ), upper threshold for error α |
| 2: | C_{EVALED} ← [symbol] |
| 3: | for c in C do |
| 4: | c.error ← EVAL [symbol] (c, [symbol] ) |
| 5: | if c.error < α then |
| 6: | s ← −c.model_size × c.error |
| 7: | C_{EVALED} ← C_{EVALED} + [(c, s)] |
| 8: | end if |
| 9: | end for |
| 10: | Output: C_{EVALED} |

At step 3 in Algorithm 1, the global historical population G is initialized as an empty data set.

At step 4 in Algorithm 1, the current population P is initialized to include a plurality of seed candidate architectures. These seed models are evaluated using the same evaluation function EVALT (c, D) that is used to evaluate new candidate architectures. The evaluation function EVALT (c, D) trains a neural network that has a candidate architecture (represented by c) on the training data D and returns the lowest validation error encountered during the training. At step 6 of Algorithm 1 and in Algorithm 2, in CROSSMUT(π_{θ}_{ₜ}, P, m, k, n), π_{θ} is the language model that processes m input prompts to generate, for each of the m input prompts, n new candidate architectures. Each of the m input prompts includes source code defining k candidate architectures.

The implementations of the evolutionary search techniques discussed in this specification generally involve maintaining both current population data and global historical population data to facilitate the search. However, maintaining the current population data is optional and not a necessity. That is, the same techniques can also be implemented by maintaining only global historical population data. In implementations where the system maintains only global historical population data, CROSSMUT could be modified to include an extra step of selecting the competent candidate architectures from the historical population of candidate architectures G.

At step 7 of Algorithm 1 and in Algorithm 3, in FILTERANDEVAL(C,T, D, α), the validation error threshold α is an upper limit of the validation error that a neural network having a new candidate architecture can incur without being removed from the global historical population G.

At step 8 of Algorithm 1, the remaining new candidate architectures and their associated fitness measures are added into global historical population G.

At step 10 of Algorithm 1, GETTOP(G, p) refers to selecting the p models with the highest fitness measure from the global historical population G. In other words, after evaluating the new candidate architectures in the current round, a fitness measure-based selection is applied to identify best performing new candidate architectures for crossover.

At step 11 of Algorithm 1, all new candidate architectures generated in the current round that were not selected for crossover (i.e. C_{EVALED} \P) are used to prompt-tune the language model π_{θ} (i.e., to adjust the prompt parameters of the language model as of the current round) for the next round. In implementations where the system maintains only global historical population data, the prompt tuning step could be modified to include an extra step to ensure that the competent candidate architectures from the historical population of candidate architectures G are not used to prompt-tune the language model π_{θ}.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving training data for training a neural network to perform a machine learning task, the training data comprising a plurality of training examples and a respective target output for each of the training examples;
searching for a final architecture of the neural network for performing the machine learning task using a language model neural network, wherein the searching comprises:
maintaining current population data that includes, for each candidate architecture in a current population of candidate architectures, (i) source code defining the candidate architecture, and (ii) a fitness measure representing a performance of the candidate architecture; and
repeatedly performing evolutionary architecture search operations comprising:
selecting one or more candidate architectures from the current population of candidate architectures defined by the source code included in the current population data;
generating an input prompt that comprises (i) the source code defining the one or more selected candidate architectures and (ii) a set of performance metrics of the one or more selected candidate architecture;
processing the input prompt using the language model neural network in accordance with current parameter values of the language model neural network to generate output source code that defines a plurality of new candidate architectures; and
using the plurality of new candidate architectures defined by the output source code to update the current population data.

2. The method of claim 1, wherein updating the current population comprises, for each new candidate architecture:
training a neural network having the new candidate architecture on the training data until termination criteria for the training are satisfied;
determining a fitness measure of the neural network having the new candidate architecture after the training; and
adding data defining the new candidate architecture and the fitness measure of the neural network having the new architecture to global historical population data that includes a historical population of candidate architectures.

3. The method of claim 2, wherein updating the current population data comprises:
selecting, from among the historical population of candidate architectures included in the global historical population data, one or more competent candidate architectures that each have a fitness measure that satisfy a fitness measure threshold; and
adding the one or more competent candidate architectures to the current population of candidate architectures included in the current population data.

4. The method of claim 3, wherein updating the current population data comprises:
removing the one or more competent candidate architectures from the global historical population data.

5. The method of claim 1, wherein maintaining the current population data comprises computing the fitness measure for each candidate architecture from a set of performance metrics of the candidate architecture, and wherein the set of performance metrics comprise a validation error of the neural network having the candidate architecture that was determined during the training and a size of the neural network having the candidate architecture.

6. The method of claim 1, wherein the evolutionary architecture search operations further comprise:
determining a difference set between (i) the plurality of new candidate architectures defined by the output source code and (ii) the current population of candidate architectures included in the current population data, wherein the difference set comprises new candidate architectures that have been generated by using the language model neural network but are not selected for inclusion in the current population of candidate architectures; and
adjusting the language model neural network using source code defining the unselected, new candidate architectures in the difference set.

7. The method of claim 6, wherein adjusting the language model neural network comprises:
using prompt tuning techniques to adjust the language model neural network.

8. The method of claim 1, wherein the input prompt also comprises a set of target performance metrics of the one or more new candidate architectures.

9. The method of claim 8, wherein generating the input prompt comprises:
determining, as the set of target performance metrics, performance metrics that improve over the sets of performance metrics of the one or more selected candidate architectures.

10. The method of claim 1, wherein the searching comprises:
initializing the global historical population data that includes no candidate architectures; and
initializing the current population data with a plurality of seed candidate architectures.

11. The method of claim 1, wherein the searching comprises, after repeatedly performing the evolutionary architecture search steps:
selecting the candidate architecture in the historical population of candidate architectures having the best fitness measure as the final architecture of the neural network.

12. The method of claim 1, wherein the final architecture of the neural network is an architecture of one of: a graph neural network, a feed-forward neural network, or a recurrent neural network.

13. A system comprising one or more computers and one or more storage devices storing instructions that are operable, when executed by the one or more computers, to cause the one or more computers to perform operations comprising:
receiving training data for training a neural network to perform a machine learning task, the training data comprising a plurality of training examples and a respective target output for each of the training examples;
searching for a final architecture of the neural network for performing the machine learning task using a language model neural network, wherein the searching comprises:
maintaining current population data that includes, for each candidate architecture in a current population of candidate architectures, (i) source code defining the candidate architecture, and (ii) a fitness measure representing a performance of the candidate architecture; and
repeatedly performing evolutionary architecture search operations comprising:
selecting one or more candidate architectures from the current population of candidate architectures defined by the source code included in the current population data;
generating an input prompt that comprises (i) the source code defining the one or more selected candidate architectures and (ii) a set of performance metrics of the one or more selected candidate architecture;
processing the input prompt using the language model neural network in accordance with current parameter values of the language model neural network to generate output source code that defines a plurality of new candidate architectures; and
using the plurality of new candidate architectures defined by the output source code to update the current population data.

14. The system of claim 13, wherein updating the current population comprises, for each new candidate architecture:
training a neural network having the new candidate architecture on the training data until termination criteria for the training are satisfied;
determining a fitness measure of the neural network having the new candidate architecture after the training; and
adding data defining the new candidate architecture and the fitness measure of the neural network having the new architecture to global historical population data that includes a historical population of candidate architectures.

15. The system of claim 14, wherein updating the current population data comprises:
selecting, from among the historical population of candidate architectures included in the global historical population data, one or more competent candidate architectures that each have a fitness measure that satisfy a fitness measure threshold; and
adding the one or more competent candidate architectures to the current population of candidate architectures included in the current population data.

16. The system of claim 15, wherein updating the current population data comprises:
removing the one or more competent candidate architectures from the global historical population data.

17. The system of claim 13, wherein maintaining the current population data comprises computing the fitness measure for each candidate architecture from a set of performance metrics of the candidate architecture, and wherein the set of performance metrics comprise a validation error of the neural network having the candidate architecture that was determined during the training and a size of the neural network having the candidate architecture.

18. The system of claim 13, wherein the evolutionary architecture search operations further comprise:
determining a difference set between (i) the plurality of new candidate architectures defined by the output source code and (ii) the current population of candidate architectures included in the current population data, wherein the difference set comprises new candidate architectures that have been generated by using the language model neural network but are not selected for inclusion in the current population of candidate architectures; and
adjusting the language model neural network using source code defining the unselected, new candidate architectures in the difference set.

19. The system of claim 18, wherein adjusting the language model neural network comprises:
using prompt tuning techniques to adjust the language model neural network.

20. A computer storage medium encoded with instructions that, when executed by one or more computers, cause the one or more computers to perform operations comprising:
receiving training data for training a neural network to perform a machine learning task, the training data comprising a plurality of training examples and a respective target output for each of the training examples;
searching for a final architecture of the neural network for performing the machine learning task using a language model neural network, wherein the searching comprises:
maintaining current population data that includes, for each candidate architecture in a current population of candidate architectures, (i) source code defining the candidate architecture, and (ii) a fitness measure representing a performance of the candidate architecture; and
repeatedly performing evolutionary architecture search operations comprising:
selecting one or more candidate architectures from the current population of candidate architectures defined by the source code included in the current population data;
generating an input prompt that comprises (i) the source code defining the one or more selected candidate architectures and (ii) a set of performance metrics of the one or more selected candidate architecture;
processing the input prompt using the language model neural network in accordance with current parameter values of the language model neural network to generate output source code that defines a plurality of new candidate architectures; and
using the plurality of new candidate architectures defined by the output source code to update the current population data.
